(19) United States
(12) Patent Application Publication
(10) Pub. No.: US 2022/0370287 A1
(43) Pub. Date: Nov. 24, 2022

(54) MASSAGE DEVICE WITH REPLACEABLE STRUCTURE

(71) Applicant: Shenzhen Alltokee Technology Co., Ltd, Shenzhen (CN)

(72) Inventor: Minyi Huang, Lianping (CN)

(73) Assignee: Shenzhen Alltokee Technology Co., Ltd, Shenzhen (CN)

(21) Appl. No.: 17/835,989

(22) Filed: Jun. 9, 2022

(51) Int. Cl. A61H 23/02

(52) U.S. Cl. CPC A61H 23/02; A61H 2201/1207

(57) ABSTRACT

A massage device with a replaceable structure is provided, including a rod body and a massage subassembly; the rod body has a first mounting cavity; the first mounting cavity is provided with a Printed Circuit Board (PCB); the rod body has a mounting opening; the mounting opening is provided with a first conducting contact; the PCB is electrically connected to the first conducting contact; the massage subassembly is provided with a motor module; and the motor module is electrically connected to a second conducting contact. During mounting, the massage subassembly is mounted at the mounting opening; and the first conducting contact is correspondingly connected to the second conducting contact.

### TECHNICAL FIELD

The present disclosure relates to a massage device with a replaceable structure.

### BACKGROUND ART

The statements here only provide the background information related to the present disclosure, and do not necessarily constitute the prior art.

People will use a massage device to get relaxed. The massage device can relax the human body tissues by generating vibration. Therefore, these massage devices are widely used in people's life. However, the existing massage device includes a rod body and a massage subassembly fixed on the rod body. Since they are fixed and unremovable, a massage mode is also non-changeable, which cannot make people feel more relaxed and has low interestingness.

The inventor realizes that there is no massage device that can improve the interestingness and has a replaceable massage subassembly.

### SUMMARY

A massage device with a replaceable structure includes a rod body and a massage subassembly detachably mounted on the rod body; a first mounting cavity is formed inside the rod body; a Printed Circuit Board (PCB) and a power supply are mounted in the first mounting cavity; the rod body has a mounting opening used for mounting the massage subassembly; a first conducting contact is arranged at the mounting opening; the PCB is electrically connected to the first conducting contact;

a motor module is arranged in the massage subassembly; the motor module is electrically connected to a second conducting contact corresponding to the first conducting contact; during mounting, the massage subassembly is mounted at the mounting opening; and the first conducting contact is correspondingly connected to the second conducting contact, so that the PCB is electrically connected to the motor module.

In some embodiments, a first magnet is arranged at the mounting opening; a second magnet matched with the first magnet is arranged on the massage subassembly; and during mounting, the first magnet and the second magnet attract each other.

In some embodiments, the mounting opening comprises a mounting groove and a mounting recessed platform located on an opening side of the mounting groove;

a mounting end of the massage subassembly is matched with the mounting recessed platform, and the mounting end of the massage subassembly downwards extends to form a mounting convex column matched with the mounting groove; and during mounting, the mounting convex column is located in the mounting groove, and the mounting end of the massage subassembly is located on the mounting recessed platform.

In some embodiments, the mounting groove is a quadrangle, one pair of opposite sides of which is mutually parallel straight sides, and the other pair of opposite sides of which is arc sides.

In some embodiments, the first conducting contact is arranged on the mounting groove; and the second conducting contact is arranged on the mounting convex column.

In some embodiments, the first magnet is arranged in the mounting groove; and the second magnet is arranged in the mounting convex column.

In some embodiments, an outer side surface of the rod body is covered with a silica gel layer.

In some embodiments, the mounting opening is provided with a locating bulge; and the massage subassembly is provided with a locating slot matched with the locating bulge.

Compared with the prior art, the present disclosure has obvious advantages and beneficial effects. Specifically, it can be mainly known from the above technical solution that by the design of a massage device with a magnetic replaceable structure, removability and replaceability are achieved, and the replaced massage subassembly can also be ensured to be electrically connected to the PCB in the rod body, so that a manufacturer can manufacture various massage subassemblies with different functions to be used with the rod body, which further increases massage modes, meets requirements of different people, and improves the interestingness of a product.

In order to describe the structural features and effects of the present disclosure more clearly, the present disclosure is described in detail below in combination with the accompanying drawings and specific embodiments.

### BRIEF DESCRIPTION OF THE DRAWINGS

FIG. 1 is a schematic three-dimensional diagram of an embodiment of the present disclosure;

FIG. 2 is an exploded diagram of an embodiment of the present disclosure;

FIG. 3 is a first schematic sectional diagram of an embodiment of the present disclosure;

FIG. 4 is a partially enlarged diagram of FIG. 3;

FIG. 5 is a second schematic sectional diagram of an embodiment of the present disclosure;

FIG. 6 is a partially enlarged diagram of FIG. 5;

FIG. 7 is another exploded diagram of an embodiment of the present disclosure;

FIG. 8 is a schematic diagram of application of an embodiment of the present disclosure.

### REFERENCE SIGNS IN THE DRAWINGS

10: rod body; 101: silica gel layer; 11: first mounting cavity; 12: PCB; 13: power supply; 14: mounting opening; 141: first conducting contact; 142: first magnet; 143: mounting groove; 144: mounting recessed platform; 20: massage subassembly; 21: second mounting cavity; 22: motor module; 221: second conducting contact; 23: second magnet; 24: mounting convex pillar; 25: massage sheet; and 26: impeller.

### DETAILED DESCRIPTION OF THE EMBODIMENTS

The technical solutions in the embodiments of the present disclosure will be clearly and completely described below in conjunction with the accompanying drawings. Apparently, the described embodiments are only preferred embodiments of the present disclosure.

It should be noted that when an element is referred to as being “fixed” to another element, it can be directly on the other element or an intermediate element may also exist. When an element is considered to be “connected” to another element, it can be directly connected to the other element or an intermediate element may be present at the same time. The terms “perpendicular”, “horizontal”, “left”, “right” and similar expressions used herein are for illustrative purposes only, and are not meant to be the only implementation modes.

Unless otherwise defined, all technical and scientific terms used herein are the same as meanings of general understandings of those skilled in the art of the disclosure. The terms used in the description of the present disclosure herein are merely to describe the specific implementation modes, not intended to limit the present disclosure. The term “and/or” used herein includes any and all combinations of one or more related listed items.

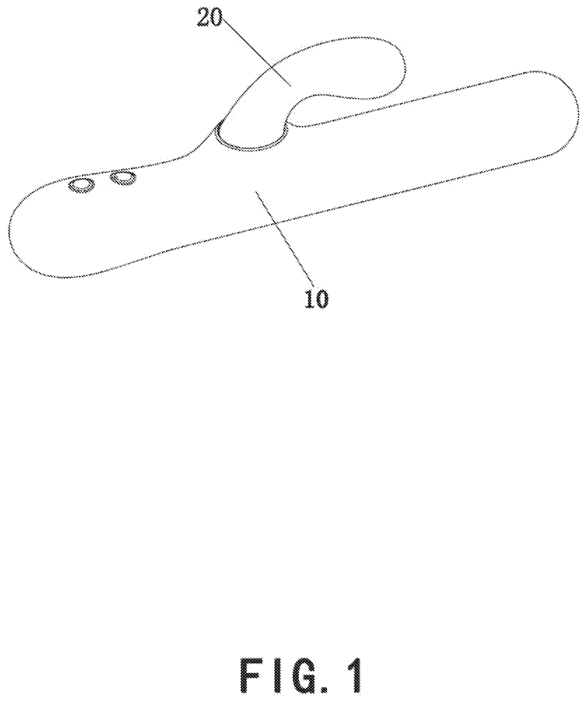

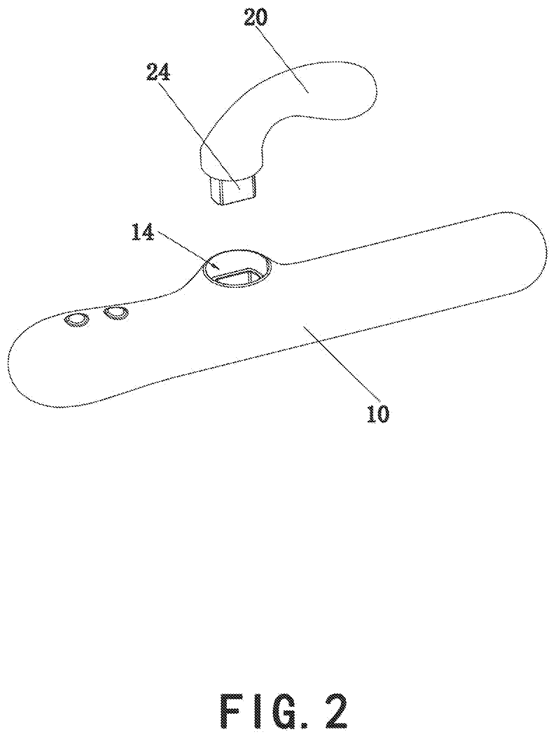

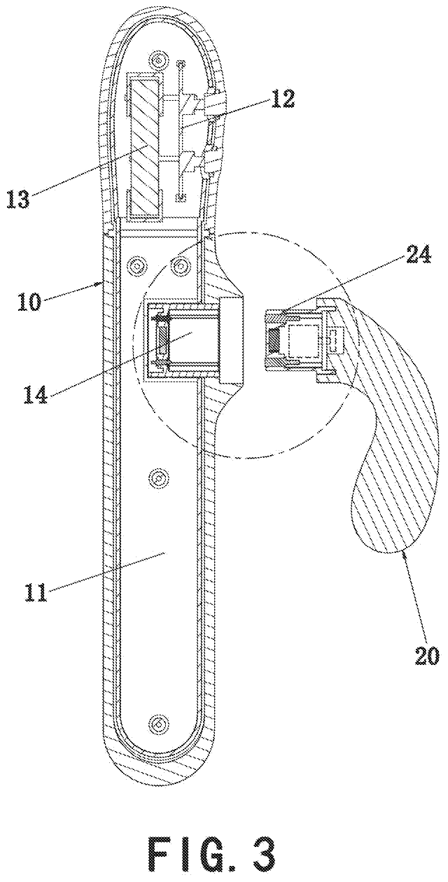

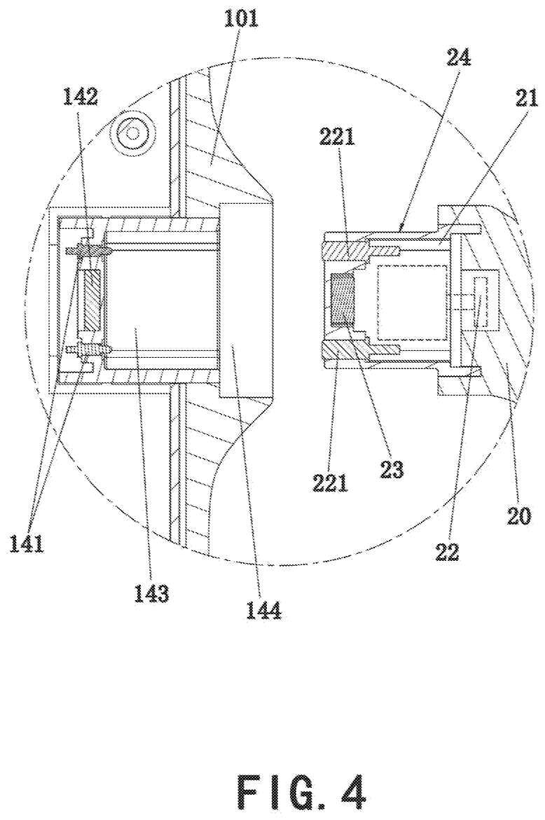

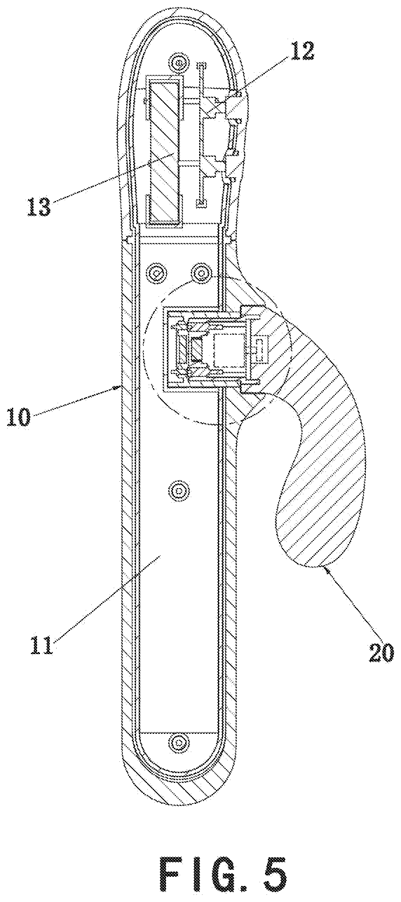

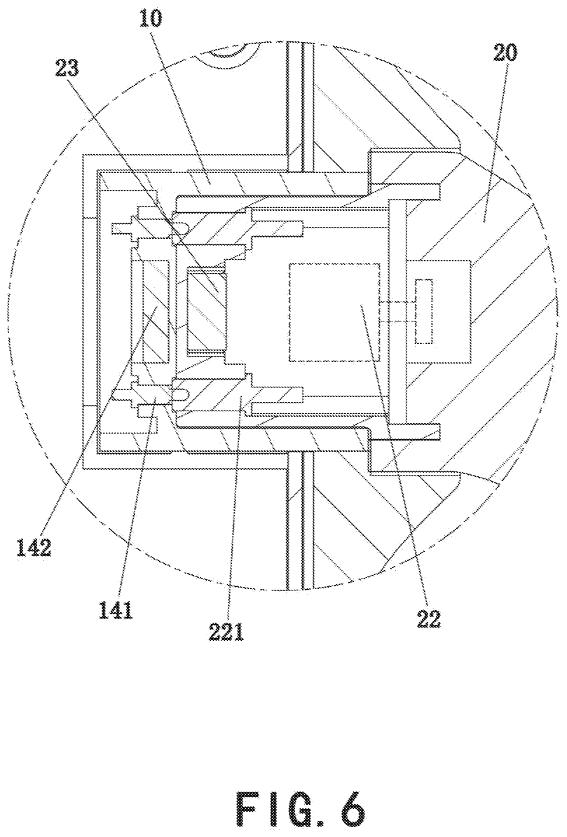

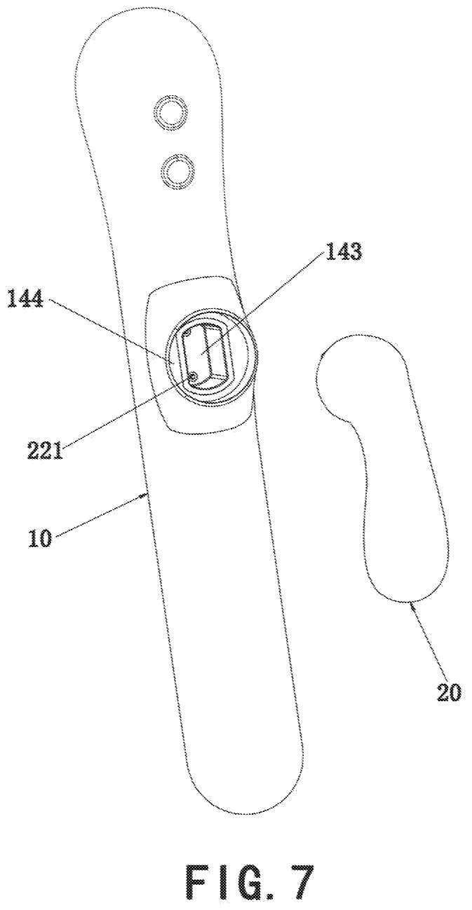

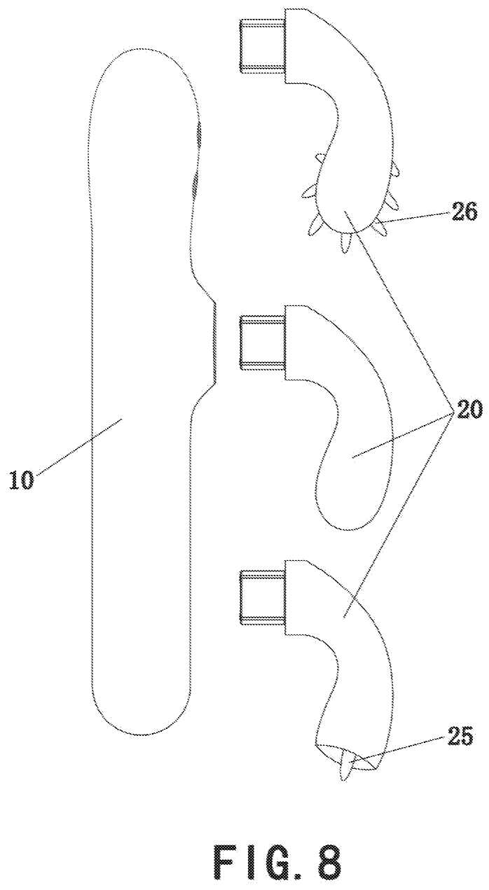

Referring to FIG. 1 to FIG. 8, a massage device with a replaceable structure in an embodiment of the present disclosure includes a rod body 10 and a massage subassembly 20 detachably mounted on the rod body 10; a first mounting cavity 11 is formed inside the rod body 10; a PCB 12 and a power supply 13 are mounted in the first mounting cavity 11; the rod body 10 has a mounting opening 14 used for mounting the massage subassembly 20; a first conducting contact 141 is arranged at the mounting opening 14; and the PCB 12 is electrically connected to the first conducting contact 141.

The massage subassembly 20 internally has a second mounting cavity 21 and a motor module 22 arranged in the second mounting cavity 21. The motor module 22 is electrically connected to a second conducting contact 221 corresponding to the first conducting contact 141. During mounting, the massage subassembly 20 is mounted at the mounting opening 14; and the first conducting contact 141 is correspondingly connected to the second conducting contact 221, so that the PCB 12 is electrically connected to the motor module 22.

As such, by the design of a replaceable structure for the subassembly, removability and replaceability are achieved, and the replaced massage subassembly 20 can also be ensured to be electrically connected to the PCB 12 in the rod body 10, so that a manufacturer can manufacture various massage subassemblies 20 with different functions to be used with the rod body 10, which meets requirements of different people, and improves the interestingness of a product.

Specifically, the PCB 12 is also electrically connected to a start/stop button and a power conversion button; the power supply 13 is a rechargeable storage battery; the first conducting contact includes two conductive elastic probes; and the second conducting contact also includes two conductive elastic probes.

Preferably, a first magnet 142 is arranged at the mounting opening 14; and a second magnet 23 matched with the first magnet 142 is arranged on the massage subassembly 20. During mounting, the first magnet 142 and the second magnet 23 attract each other. As such, the magnets are correspondingly arranged on the mounting opening 14 and the massage subassembly 20 to increase the connection strength, so that a product is more stable and reliable during use. The first magnet 142 and the second magnet 23 may be magnets with opposite magnetisms. The first magnet 142 and the second magnet 23 may also be magnetic metal members.

Preferably, the mounting opening 14 includes a mounting groove 143 and a mounting recessed platform 144 located on an opening side of the mounting groove 143.

A mounting end of the massage subassembly 20 is matched with the mounting recessed platform 144, and the mounting end of the massage subassembly 20 downwards extends to form a mounting convex column 24 matched with the mounting groove 143. During mounting, the mounting convex column 24 is located in the mounting groove 143, and the mounting end of the massage subassembly 20 is located on the mounting recessed platform 144. As such, by the design of the mounting groove 143 and the mounting convex column 24 for locating and mounting, the convenience of mounting is improved, and the mounting difficulty is lowered. Moreover, the mounting recessed platform 144 is arranged at an opening in an upper side of the mounting groove 143 to further stabilize the massage subassembly 20, thus further improving the reliability of use of a product after the massage subassembly 20 is mounted.

Further, the mounting groove 143 is a quadrangle, one pair of opposite sides of which is mutually parallel straight sides, and the other pair of opposite sides of which is arc sides. Correspondingly, the mounting convex column 24 is also a quadrangle matched with the mounting groove 143. Compared with a circle, a quadrangle can ensure that the first conducting contact 141 and the second conducting contact 221 can be in effective contact and can also prevent the problem that the mounted massage subassembly 20 is spinning around.

Further, the first conducting contact 141 is arranged on the mounting groove 143; and the second conducting contact 221 is arranged on the mounting convex column 24.

Similarly, the first magnet 142 is arranged in the mounting groove 143; and the second magnet 23 is arranged in the mounting convex column 24.

Preferably, an outer side surface of the rod body 10 is covered with a silica gel layer 101. Preferably, an outer side surface of the massage subassembly 20 is also covered with a silica gel layer 101 to improve the flexibility of the product.

Further, the motor module 22 may be a vibration motor arranged in the massage subassembly 20. The motor module 22 vibrates to drive the massage subassembly 20 to vibrate, thus providing a “vibration massage mode” to users. The vibration motor can also be in driving connection with a massage sheet 25. Users are massaged by the massage sheet 25.

Of course, the motor module 22 can also be a small motor arranged in the massage subassembly 20. The small motor is rotatably connected to an impeller. Users are massaged through rotation of the impeller.

In some embodiments, the mounting opening 14 can also be fastened in other ways, such as a fastener structure, instead of using magnet attraction. Specifically, the mounting opening 14 is provided with a locating bulge; and the massage subassembly 20 is provided with a locating slot matched with the locating bulge. By means of cooperation between the locating bulge and the locating slot, the connection stability between the rod body 10 and the massage subassembly 20 is improved.

The design point of the present disclosure is as follows: By the design of a massage device with a magnetic replaceable structure, removability and replaceability are achieved, and the replaced massage subassembly can also be ensured to be electrically connected to the PCB in the rod body, so that a manufacturer can manufacture various massage subassemblies with different functions to be used with the rod body, which further increases massage modes, meets requirements of different people, and improves the interestingness of a product.

The above descriptions are only preferred embodiments of the present disclosure, and do not limit the technical scope of the present disclosure. Therefore, any minor changes, equivalent changes and modifications made to the above embodiments according to the technical essence of the present disclosure still fall within the scope of the technical solutions of the present disclosure.

What is claimed is:

1. A massage device with a replaceable structure, comprising a rod body and a massage subassembly detachably mounted on the rod body, wherein a first mounting cavity is formed inside the rod body; a Printed Circuit Board (PCB) and a power supply are mounted in the first mounting cavity; the rod body has a mounting opening used for mounting the massage subassembly; a first conducting contact is arranged at the mounting opening; the PCB is electrically connected to the first conducting contact;
a motor module is arranged in the massage subassembly; the motor module is electrically connected to a second conducting contact corresponding to the first conducting contact; during mounting, the massage subassembly is mounted at the mounting opening; and the first conducting contact is correspondingly connected to the second conducting contact, so that the PCB is electrically connected to the motor module.

2. The massage device with the replaceable structure according to claim 1, wherein a first magnet is arranged at the mounting opening; a second magnet matched with the first magnet is arranged on the massage subassembly; and during mounting, the first magnet and the second magnet attract each other.

3. The massage device with the replaceable structure according to claim 2, wherein the mounting opening comprises a mounting groove and a mounting recessed platform located on an opening side of the mounting groove;
a mounting end of the massage subassembly is matched with the mounting recessed platform, and the mounting end of the massage subassembly downwards extends to form a mounting convex column matched with the mounting groove; and during mounting, the mounting convex column is located in the mounting groove, and the mounting end of the massage subassembly is located on the mounting recessed platform.

4. The massage device with the replaceable structure according to claim 3, wherein the mounting groove is a quadrangle, one pair of opposite sides of which is mutually parallel straight sides, and the other pair of opposite sides of which is arc sides.

5. The massage device with the replaceable structure according to claim 4, wherein the first conducting contact is arranged on the mounting groove; and the second conducting contact is arranged on the mounting convex column.

6. The massage device with the replaceable structure according to claim 4, wherein the first magnet is arranged in the mounting groove; and the second magnet is arranged in the mounting convex column.

7. The massage device with the replaceable structure according to claim 2, wherein an outer side surface of the rod body is covered with a silica gel layer.
